(19) United States
(12) Patent Application Publication
(10) Pub. No.: US 2015/0049020 A1
(43) Pub. Date: Feb. 19, 2015

(54) DEVICES AND METHODS FOR ELECTRONIC POINTING DEVICE ACCELERATION

(71) Applicant: LENOVO (SINGAPORE) PTE. LTD., Singapore (SG)

(72) Inventors: Mitsuhiro Yamazaki, Yokohama-Shi (JP); Fusanobu Nakamura, Yamato-Shi (JP); Akihiko Mizutani, Yamato-shi (JP)

(73) Assignee: LENOVO (SINGAPORE) PTE. LTD., Singapore (SG)

(21) Appl. No.: 13/970,106

(22) Filed: Aug. 19, 2013

(51) Int. Cl. G06F 3/0354

(52) U.S. Cl. CPC G06F 3/03543
USPC 345/163

(57) ABSTRACT

Devices and methods are provided for electronic pointing device acceleration. In general, the devices and methods can facilitate adjustment of a speed of a cursor's movement on a display screen. In one embodiment, an electronic device can include a pointing device configured to control movement of a cursor on the electronic device's display screen. A user's input to the pointing device can indicate a desired distance and directional movement of the cursor on the screen. The electronic device can also include an accelerator element configured to control a speed of the cursor's movement on the screen. A user's input to the accelerator element can indicate a desired increase in the cursor's speed and cause the cursor to move more quickly on the screen. The electronic device can include the pointing device and the accelerator element at locations compatible with typical typing positions of a user's hands.

### FIELD OF THE INVENTION

The present invention relates generally to devices and methods for electronic pointing device acceleration.

### BACKGROUND OF THE INVENTION

Many computer systems include an input device that allows physical actions of a user to be translated into manipulations of a graphical user interface of the computer system. For example, most desktop computers are configured with a pointing device such as a mouse. When the mouse is moved relative to a fixed surface, movement of an on-screen cursor occurs in a direction and at a speed that corresponds to the physical movement of the mouse.

While the basic mouse has enjoyed widespread adoption as an input device for desktop computers, it can be less practical for use with portable computer systems or systems that are situated in a cluttered work environment. A number of pointing devices have been developed for such systems.

A first type of pointing device includes a pointing stick or small joystick, generally referred to herein as a “stick.” The stick includes a finger pad coupled to a small shaft that pivots relative to a fulcrum point. The direction in which the stick is angled relative to the fulcrum point is used to determine a direction to move the on-screen cursor, and a force applied to the stick is used to determine a speed at which to move the on-screen cursor. One advantage to this type of pointing device is that it can be positioned in proximity to a keyboard, e.g., in the center of a keyboard as in the case of a laptop computer. This proximity allows a user to switch between using the keyboard and using the pointing device without having to move their hands from a “home” position. However, a user can find it difficult to reliably apply the correct amount of input force to the stick. U.S. Pat. No. 5,764,219 to Rutledge et al. discloses signal processing that can be used with pointing devices of the first type in which input force applied to the stick is related to a velocity of a cursor on a video screen according to a transfer function.

A second type of pointing device includes an optical scanner that reads the swipe of a user's finger. While this type of pointing device generally does not have moving parts, it requires several swipe actions by the user when moving a cursor for a long distance, which is inefficient and can cause user discomfort, fatigue, and/or annoyance. This type of pointing device also usually requires movement of the user's hands from the home position, which can create user discomfort, take time, and/or cause user annoyance. U.S. Pat. No. 6,552,713 to Van Brocklin et al., U.S. Pat. No. 6,057,540 to Gordon et al., and Japanese Publication No. 2003-216321 to Kato disclose pointing devices of the second type. Van Brocklin relies on motion of a user's finger relative to a fixed surface to determine cursor speed and direction. Gordon provides a transparent stud over an image sensor, and movement of a user's finger across a top surface of the stud is detected and translated into motion of a cursor. Kato provides a dome-shaped cover over an image pickup element which captures a video signal of a user's finger moving across the dome-shaped cover, and this movement detection is used to control movement of a cursor on a display.

A third type of pointing device includes a jog ball mounted within a recess and configured to rotate first and second orthogonal rollers when the ball is manipulated by a user. Pointing devices of the third type can be broken easily when excessive operating force is applied.

A fourth type of pointing device includes a trackpad, a pressure sensitive pad such as the ForcePad™, or a touchpad, generally referred to herein as a “touchpad,” that translates tactile input, e.g., a user's finger swipe on the touchpad, into cursor movement. Similar to the second type, this type of pointing device generally does not have moving parts, but it requires several swipe actions by the user when moving a cursor for a long distance, which is inefficient and can cause user discomfort, fatigue, and/or annoyance.

Repeated use of a pointing device, as during a typical session of using a computer system, can cause user pain, finger or hand fatigue, and/or repetitive stress injuries. Similarly, repeated application of excessive force to the pointing device to obtain fast cursor movement can lead to user pain, finger or hand fatigue, and repetitive stress injuries. Adverse effects of using a pointing device are becoming more magnified in modern computer systems having a high resolution display, a large display size, multiple displays, and/or wide user interface design since more movement and/or more force is applied to the pointing device to move the cursor around the display(s).

Some computer systems allow sensitivity of a pointing device to be adjusted via a control panel for the computer system. However, these sensitivity adjustments, which can cause a cursor to move at a certain selected speed in response to input to the pointing device, interrupt work flow because a user must access the control panel in a system window to adjust the sensitivity and must access the control panel each time a change in sensitivity is desired.

Accordingly, there remains a need for improved devices and methods for electronic pointing device acceleration.

### SUMMARY OF THE INVENTION

In one embodiment, an apparatus is provided that includes a pointing device and an accelerator element. The pointing device can be configured to receive a first input from a first hand of a user. The first input can indicate a request that a cursor move on a display screen from a first position on the screen to a second position on the screen. The accelerator element can be configured to receive a second input from a second hand of the user simultaneously with receipt of the first input. The second input can indicate a request that the cursor to move on the screen as requested by the first input at a speed greater than a current speed of the cursor.

The apparatus can vary in any number of ways. For example, a time duration of the second input can indicate how much to increase the speed over the current speed. For another example, the first speed can gradually increase until the accelerator element ceases to receive the second input.

For another example, the apparatus can include a decelerator element configured to receive a third input from the second hand of the user simultaneously with receipt of the first input. The third input can request that the cursor to move on the screen as requested by the first input at a speed less than the current speed of the cursor.

For yet another example, the apparatus can include a housing of an electronic device, and a keyboard coupled to the housing. The pointing device can be coupled to the housing at a first lateral location relative to the keyboard. The accelerator element can be coupled to the housing at a second lateral location relative to the keyboard that is different than the first lateral location. When the first and second hands of the user are in a typical position for typing on the keyboard, the pointing device can be configured to receive the first input from a finger of the first hand of the user and the accelerator element can be configured receive the second input from a palm of the second hand of the user.

The pointing device can include at least one of a stick, a mouse, a touchpad, a jog ball, and an optical scanner.

The accelerator element can include at least one of a pressure sensor and a switch.

In another embodiment, an apparatus is provided that includes a pointing device, an accelerator element, and a processor. The pointing device can be configured to receive a first input from a user. The first input can indicate a request for a cursor to move on a display screen. The accelerator element can be separated at a distance from the pointing device and can be configured to receive a second input from the user. The second input can indicate a request for the cursor to move on the screen at a first speed greater than a current speed of the cursor. The processor can be configured to, prior to the accelerator element receiving the second input, cause the cursor to move on the screen at the current speed in response to the first input. The processor can be configured to, after the accelerator element receives the second input, cause the cursor to move on the screen at the first speed in response to the first input.

The apparatus can vary in any number of ways. For example, a time duration of the second input can indicate how much to increase the first speed over the current speed. For another example, the processor can be configured to gradually increase the first speed until the accelerator element ceases to receive the second input. For yet another example, the pointing device can be configured to receive the first input from a first hand of the user and the accelerator element can be configured receive the second input from a second hand of the user simultaneously with the pointing device receiving the first input. For another example, the accelerator element can include a pressure sensor, and the processor can be configured to increase the first speed according to a level of pressure detected by the pressure sensor as the second input.

For another example, the apparatus can include a decelerator element separated at a second distance from the pointing device and separated at a third distance from the accelerator element. The decelerator element can be configured to receive a third input from the user. The third input can indicate a request for the cursor to move on the screen. The processor can be configured to, prior to the accelerator element receiving the second input and prior to the decelerator element receiving the third input, cause the cursor to move on the screen at the current speed in response to the first input. The processor can be configured to, prior to the accelerator element receiving the second input and after the decelerator element receives the third input, cause the cursor to move on the screen at a second speed in response to the first input, the second speed being less than the current speed. The processor can be configured to, after the accelerator element receives the second input and after the decelerator element receives the third input, cause the cursor to move on the screen at a third speed in response to the first input, the third speed being less than the first speed. For still another example, the processor can be configured to, after the accelerator element receives the second input and prior to the decelerator element receiving the third input, cause the cursor to move on the screen at the first speed in response to the first input. The processor can be configured to, after the accelerator element receives the second input and after the decelerator element receives the third input, cause the cursor to move on the screen at a second speed in response to the first input, the second speed being less than the first speed.

The pointing device can include at least one of a stick, a mouse, a touchpad, a jog ball, and an optical scanner.

The accelerator element can include at least one of a pressure sensor and a switch.

In another aspect, a method is provided. In one embodiment, the method includes receiving a first input from a first hand of a user. The first input can be received at a pointing device of an electronic device, and the first input can indicate a request that a cursor move on a display screen of the electronic device from a first position on the screen to a second position on the screen. The method can also include receiving a second input from a second hand of the user. The second input can be received at an accelerator element of the electronic device, and the second input can indicate a request that the cursor move on the screen at a speed faster than a current speed of the cursor. The method can also include moving the cursor on the screen as requested by the first input at the speed faster than the current speed of the cursor.

The method can have any number of variations. For example, a time duration of the second input can indicate how much to increase the speed over the current speed, and the speed can gradually increase until the second input ceases to be received at the accelerator element.

### BRIEF DESCRIPTION OF THE DRAWINGS

The invention will be more fully understood from the following detailed description taken in conjunction with the accompanying drawings, in which:

FIG. 1 is a perspective view of one embodiment of an electronic device including a pointing device, an accelerator element, a decelerator element, and a display;

FIG. 2 is a schematic diagram of the electronic device of FIG. 1;

FIG. 3 is a screenshot of one embodiment of cursor movement on the display of FIG. 1;

FIG. 4 is a screenshot of another embodiment of cursor movement on the display of FIG. 1,

FIG. 5 is a screenshot of yet another embodiment of cursor movement on the display of FIG. 1;

FIG. 6 is a screenshot of still another embodiment of cursor movement on the display of FIG. 1;

FIG. 7 is a perspective, partial view of another embodiment of an electronic device including a pointing device, an accelerator element, a decelerator element, and a display;

FIG. 8 is a perspective view of right and left hands in a typical typing position relative to the electronic device of FIG. 7;

FIG. 9 is a perspective view of right and left hands in another typical typing position relative to the electronic device of FIG. 7;

FIG. 10 is a perspective view of right and left hands in yet another typical typing position relative to the electronic device of FIG. 7;

FIG. 11 is a schematic diagram of yet another embodiment of an electronic device including a pointing device, an accelerator element, a decelerator element, and a display; and

FIG. 12 is a schematic diagram of still another embodiment of an electronic device including a pointing device, an accelerator element, a decelerator element, and a display.

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Various devices and methods are provided for electronic pointing device acceleration. In general, the devices and methods can facilitate adjustment of a speed of a cursor's movement on a display screen. In one embodiment, an electronic device can include a pointing device configured to control movement of a cursor on the electronic device's display screen. A user's input to the pointing device can indicate a desired distance and directional movement of the cursor on the screen, such as to move the cursor to an item displayed on the screen which the user would like to select or otherwise manipulate. The electronic device can also include an accelerator element configured to control a speed of the cursor's movement on the screen. A user's input to the accelerator element can indicate a desired increase in the cursor's speed and cause the cursor to move more quickly on the screen. This increased speed can move the cursor more efficiently around the screen, can save time by allowing the cursor to move quickly reach a desired location on the screen, can more quickly move the cursor across multiple display screens of the electronic device, can more quickly move the cursor across a high resolution display screen, and/or can help reduce user discomfort and/or injury. Examples of user discomfort and injury include finger or hand fatigue in using the pointing device, pain associated with using the pointing device for an extended period of time, and repetitive stress injuries associated with repeatedly using the pointing device over many days. The electronic device can include the pointing device and the accelerator element at locations compatible with typical typing positions of a user's hands. In this way, the pointing device and the accelerator element's use can be easily and intuitively integrated into a user's ordinary typing position and can be comfortable for the user to access and use. The electronic device can include the pointing device and the accelerator element at locations accessible while the cursor is moving, e.g., while the user is requesting movement of the cursor, which can allow the cursor's speed to be dynamically adjusted during movement of the cursor and to be adjusted before and/or after movement of the cursor. The accelerator element can be contained within the electronic device so as to not be visible by a user in the course of typical use of the electronic device. The accelerator element can therefore not affect a typical cosmetic appearance of the electronic device. The electronic device can also include a decelerator element also configured to control a speed of the cursor's movement on the screen. The decelerator element can be similar to the accelerator element except that a user's input to the decelerator element can indicate a desired decrease in the cursor's speed and cause the cursor to move more slowly on the screen. The decelerator element can allow the user to more finely control movement of the cursor, which can facilitate accessing tightly crowded icons, images, etc. on the display screen and/or can allow the cursor to return to a previous speed after being accelerated via the accelerator element.

A person skilled in the art will appreciate that the devices and methods disclosed herein can be implemented using any type of electronic device. Embodiments of electronic devices include a mobile telephone, a smartphone, a computer (e.g., a laptop or notebook computer, a netbook, a server, a tablet, etc.), a DVD player, a CD player, a portable music player, a gaming system, a television, a radio, a personal digital assistant (PDA), etc. In an embodiment, the electronic device is a portable device configured to be transported by a user between different locations and configured to be placed on a support surface during use and/or for storage. The electronic device can, however, be a non-portable, stationary device.

The term “display” as used herein refers to any of a variety of display devices, e.g., a liquid crystal display (LCD), a light-emitting diode (LED) screen, a cathode ray tube (CRT) screen, a touchscreen, a 3D screen, and the like. Additionally, the term “display” as used herein can refer to a display that is fixedly mounted in the same chassis or package as a base of an electronic device, as well as to displays that are removably and replaceably mounted to the same chassis or package as a base of an electronic device.

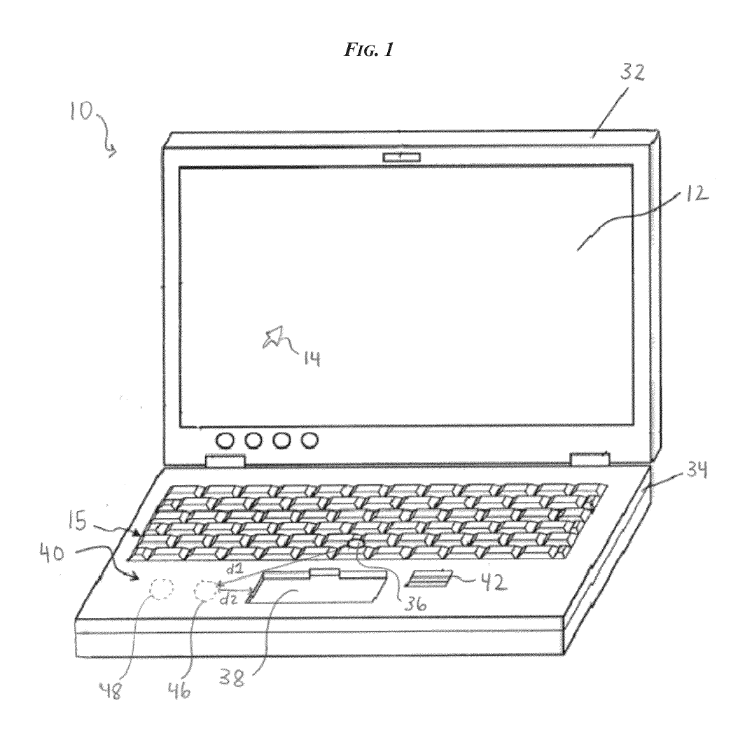

FIG. 1 illustrates one embodiment of an electronic device 10 configured to allow selective acceleration of a cursor 14 on a display screen 12 of the device 10. Although the cursor 14 is illustrated as an arrow in FIG. 1, the cursor 14 can have any of a variety of shapes, e.g., a circle, a hand, a straight line, an “I” shape, a “T” shape, etc., as will be appreciated by a person skilled in the art. Although the device 10 in this illustrated embodiment includes a laptop computer, as mentioned above, other embodiments can include other types of electronic devices. The device 10 can include any of a variety of software and/or hardware components. In addition, although an exemplary device 10 is depicted and described herein, a person skilled in the art will appreciate that this is for sake of generality and convenience. In other embodiments, the electronic device may differ in architecture and operation from that shown and described with respect to any of the illustrated embodiments.

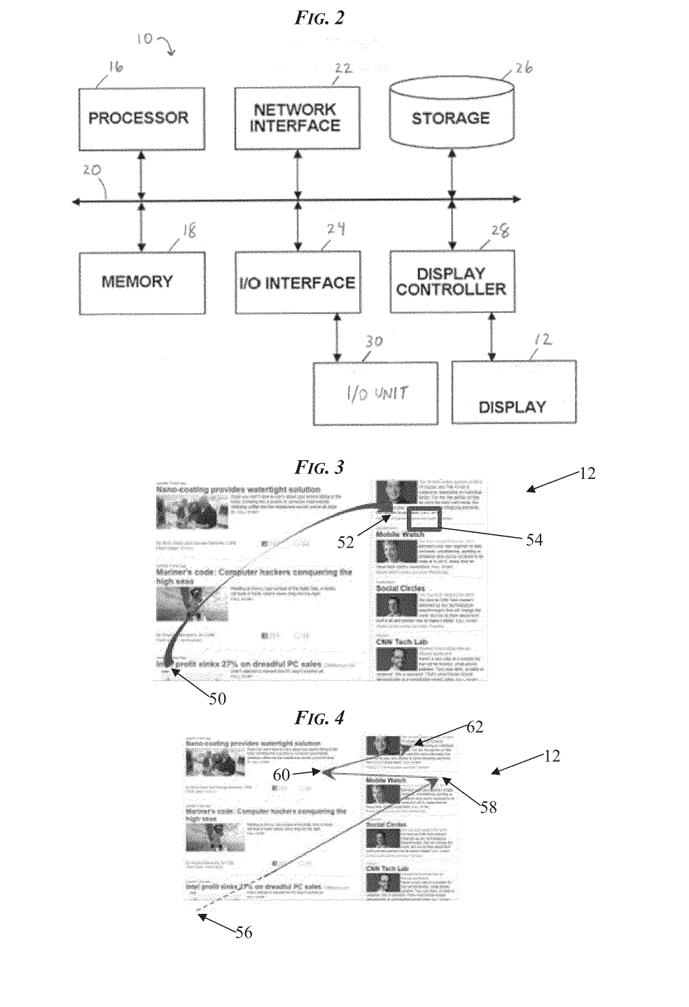

As shown in FIG. 2, the illustrated device 10 can include a processor 16 which controls the operation of the device 10, for example by executing an operating system (OS), a basic input/output system (BIOS), device drivers, application programs, and so forth. The processor 16 can include any type of microprocessor or central processing unit (CPU), including programmable general-purpose or special-purpose microprocessors and/or any one of a variety of proprietary or commercially-available single or multi-processor systems. The device 10 can also includes a memory 18, which can provide temporary storage for code to be executed by the processor 16 or for data that is processed by the processor 16. The memory 18 can include read-only memory (ROM), flash memory, one or more varieties of random access memory (RAM), and/or a combination of memory technologies. The various elements of the device 10 can be coupled to a bus system 20. The illustrated bus system 20 is an abstraction that a person skilled in the art will appreciate represents any one or more separate physical busses, communication lines/interfaces, and/or multi-drop or point-to-point connections, connected by appropriate bridges, adapters, and/or controllers.

The device 10 can also include a network interface 22, an input/output (I/O) interface 24, a storage device 26, and a display controller 28. The network interface 22 can enable the device 10 to communicate with remote devices, e.g., other electronic devices, over a network. The I/O interface 24 can facilitate communication between one or more I/O units 30. A person skilled in the art will appreciate that the device 10 can be configured to communicate with a variety of I/O units 30. Non-limiting examples of input units include a keyboard, a pointing device, and an accelerator element. Non-limiting examples of output units includes a speaker, a printer, a scanner, and a removable memory. The storage device 26 can include any conventional medium for storing data in a non-volatile and/or non-transient manner. The storage device 26 can thus hold data and/or instructions in a persistent state, i.e., the value is retained despite interruption of power to the device 10. The storage device 26 can include one or more hard disk drives, flash drives, universal serial bus (USB) drives, optical drives, various media disks or cards, and/or any combination thereof, and can be directly connected to the other components of the device 10 or remotely connected thereto, such as over a network. The display controller 28 can include a video processor and a video memory, and can generate images to be displayed on a display 12 in accordance with instructions received from the processor 16.

One or more software modules can be executed by the device 10 to facilitate human interaction with the device 10. These software modules can be part of a single program or one or more separate programs, and can be implemented in a variety of contexts, e.g., as part of an operating system, a device driver, a standalone application, and/or combinations thereof. A person skilled in the art will appreciate that any software functions being performed by a particular software module can also be performed by any other module or combination of modules.

The device 10 can be configured to open and close in a clamshell manner. A lid 32 of the device 10 and a base 34 of the device 10 can be configured to move between a closed configuration and an open configuration. As in the embodiment illustrated in FIG. 1, the device 10 can include the lid 32 hingedly connected to the base 34 to allow the device 10 to be hingedly opened and closed, as will be appreciated by a person skilled in the art. The lid 32 can include the display 12 on an inner surface thereof, and the base 34, on an inner surface 40 thereof, can include a keyboard 15, a first pointing device in the form of a stick 36, a second pointing device in the form of a touchpad 38, and a selection button 42. The device 10 can also include therein an accelerator element 46 and a decelerator element 48 under the inner surface 40 of the base 34. In this way, the display 12, the keyboard 15, the stick 36, the touchpad 38, the selection button 42, the accelerator element 46, and the decelerator element 48 can be “hidden” when the device 10 is closed, which can help protect the display 12, the keyboard 15, the stick 36, the touchpad 38, and the selection button 42 from damage when not in use. FIG. 1 shows the device 10 in an open configuration. A person skilled in the art will appreciate that when the device 10 is in the open configuration, the lid 32 and the base 34 can be at a variety of selectable angles relative to one another and not only at the angle shown in FIG. 1.

Although the display 12 in this illustrated embodiment is on the inner surface of the lid 32, the display 12 can be on any of the lid 32, the base 34, and/or an external device (e.g., an external monitor, etc). The device 10 can include more than one display 12. As will be appreciated by a person skilled in the art, the lid 32 can include any number of elements in addition to the display 12. Non-limiting examples of elements that can be included in the lid 32 are one or more additional displays, a power control (e.g., a button, a switch, etc.), a port (e.g., a USB port, a FireWire port, an Ethernet port, etc.), a close or lock latch to help hold the device 10 closed, a parameter control (e.g., brightness, contrast, etc.), etc.

As mentioned above, the inner surface 40 of the base 34 can have the keyboard 15, the stick 36, the touchpad 38, and the selection button 42 thereon, e.g., on a surface that faces the lid 32 and the display 12 when the device 10 is closed. The base 34 can include any number of additional elements. Non-limiting examples of elements that can be included in the base 34 are a media drive (e.g., a disk drive, a DVD drive, etc.), a port (e.g., a USB port, a FireWire port, an Ethernet port, etc.), a power control (e.g., a button, a switch, etc.), a WiFi network switch, a power cord outlet, a close or lock latch to help hold the device 10 closed, etc. Although the device 10 in the illustrated embodiment includes two pointing devices 36, 38, an electronic device can include any number of pointing devices, e.g., one, two, three, etc. Also, although the illustrated device 10 includes pointing devices in the form of a stick 36 and a touchpad 38, an electronic device can include any one or more types of pointing devices. Examples of pointing devices include a stick, a touchpad, a jog ball, and an optical scanner. In the illustrated embodiment, the base 34 includes in a housing thereof the processor 16, the memory 18, the bus system 20, the network interface 22, the I/O interface 24, the storage device 26, and the display controller 28 illustrated in FIG. 2. In other embodiments, as will be appreciated by a person skilled in the art, any one or more of the processor 16, the memory 18, the bus system 20, the network interface 22, the I/O interface 24, the storage device 26 can be included in the lid 32 or can be located external to the lid 32 and the base 34, e.g., an external storage device plugged into a USB port, etc.

Generally, a pointing device such as the stick 36 and the touchpad 38 receives input from a user (e.g., when a user contacts the pointing device with their finger), and the electronic device 10, e.g., the processor 16 thereof, converts the input into direction information that can be used to control movement of the cursor 14 on the display screen 12. The input can additionally be converted into distance information that can be used to control movement of the cursor 14 on the display screen 12. A person skilled in the art will appreciate that the electronic device 10 can include a control circuit implemented in hardware and/or software that can be configured to process input to the stick 36 to calculate direction parameters therefrom, and distance parameters therefrom. Thus, the control circuit can generally include a direction calculation unit and a distance calculation unit. In one embodiment, the control circuit includes an ASIC, a processor, a memory, and/or a set of logic devices that generate an output signal that can trigger the processor 16 to cause movement of the cursor 14 on the screen 12 in accordance with the output signal. The output signal can convey information indicative of the direction in which a cursor should be moved and information indicative of a distance to move the cursor. The control circuit can also be configured to similarly process input to the touchpad 38, or the device 10 can include a second control circuit configured to process input to the touchpad 38. In another embodiment, the control circuit can include at least one software-implemented pointing device driver that is executed by the processor 16 in response to input to the stick 36 and the touchpad 38.

The electronic device 10 can be preprogrammed to move the cursor 14 on the screen 12 at a default speed in response to an input to the stick 36 and/or to the touchpad 38 indicating a request to move the cursor 14 on the screen 12. The default speed can be preprogrammed during manufacturing such that the default speed is preset upon consumer purchase. The default speed can thus be an initial current speed of the cursor 14, e.g., the speed at which the cursor 14 moves on the screen 12 until the user actuates the accelerator element 46 and/or the decelerator element 48, as discussed further below. The default speed can be any speed and can generally be an intermediate speed between a minimum possible speed of the cursor 14 and a maximum possible speed of the cursor 14. The minimum and maximum possible speeds can also be preprogrammed.

The electronic device 10 can be configured to allow user adjustment of the cursor's speed up and down from the cursor's current speed. The first time a user adjusts the cursor's speed, the speed is adjusted from the initial current or preprogrammed speed. As in the illustrated embodiment, the electronic device 10 can include the accelerator element 46 configured to allow a user to increase the cursor's current speed and can include the decelerator element 48 configured to allow a user to decrease the cursor's current speed. The accelerator and decelerator elements 46, 48 can each have a variety of configurations.

The accelerator element 46 can be configured to receive an input from a user indicating a request to increase the cursor's current speed. The user can provide an input to the accelerator element 46 in a variety of ways. In one embodiment, the accelerator element 46 can include a pressure sensor configured to sense a change in pressure, e.g., detect an increase in a force by measuring a change in voltage. The pressure sensor detecting a pressure change, such as by a user pressing on the pressure sensor, can actuate the accelerator element 46 so as to provide an input thereto. Examples of the pressure sensor include a strain gauge, a semiconductor piezoresistive pressure sensor, a microelectromechanical systems (MEMS) pressure sensor (e.g., a HSPPA* Series MEMS Pressure Sensor available from Alps Electric Co., Ltd of Tokyo, Japan), and a piezoelectric pressure sensor. A user actuating the accelerator element 46, such as by pushing on the accelerator element 46, can activate the accelerator element 46 so as to cause the cursor's speed to increase. The cursor's speed can continue increasing until the pressure is released from the accelerator element 46, e.g., until the user stops pressing on the accelerator element 46. The speed can gradually increase at a consistent rate when the pressure sensor is being pressed, or the speed can gradually increase at an inconsistent rate, e.g., exponentially, when the pressure sensor is being pressed such that the speed increases at a faster rate the longer the pressure sensor is pressed. The cursor's speed can remain at the speed it was at when the pressure was released from the pressure sensor until the accelerator element 46 is again actuated or the decelerator element 48 is actuated.

The pressure sensor can be configured to provide analog level control based on a level of pressure applied by the user to the pressure sensor. In other words, an amount of pressure the user applies to the pressure sensor can define a continuous analog acceleration rate of the cursor. The more pressure applied to the pressure sensor, the faster the cursor's speed can increase. The analog force level detected by the sensor correlated to a magnitude of the cursor's speed increase can allow the cursor to accelerate faster, which can allow the cursor to more quickly reach a desired speed level and thereby improve user satisfaction.

If the user ceases to apply pressure to the pressure sensor, the cursor can be configured to return to its original speed. The pressure sensor can therefore be configured to facilitate selective up/down speed control of the cursor without altering a predetermined speed of the cursor, which is typically the user's preferred speed. The system can therefore facilitate temporary cursor speed changes for a particular user need without requiring the user to reset a default cursor speed after the cursor speed change.

In another embodiment, the cursor's speed can increase a predetermined amount each time a user actuates the accelerator element 46, e.g., each time the user presses on the accelerator element 46. For example, the cursor's speed can increase by 5%, 10%, 20%, etc. each time the accelerator element 46 is actuated. By increasing the cursor's speed by a certain amount upon a single actuation of the accelerator element 46, a user need not continuously press down or otherwise continuously actuate the accelerator element 46 to increase the cursor's speed. Instead, the user can actuate the accelerator a discrete, selectable number of times to increase the cursor's speed. The decelerator element 48 can be similarly configured to decrease the cursor's speed by a predetermined amount each time a user actuates the decelerator element 48.

The pressure sensor can be configured to actuate only after a threshold period of time has passed since a pressure change was detected. The threshold period of time can be preset and can be any length of time, e.g., 0.5 seconds. Additionally or alternatively, the pressure sensor can be configured to actuate only when pressure change above a threshold pressure change has been detected. In other words, the pressure sensor can be configured to actuate only when a threshold level of pressure is applied thereto. The threshold pressure change can be any pressure amount, which can vary between different types of pressure sensors. Starting to increase the cursor's speed only after a threshold period has passed and/or upon detection of a certain minimum amount of pressure change, the electronic device 10 can compensate for inadvertent touches of the accelerator element 46 and be less likely to increase the cursor's speed against the user's wishes.

In another embodiment, the accelerator element 46 can include a switch configured to be moved between an “on” position in which cursor speed increases and an “off” position in which cursor speed is held stable and is not increased. The accelerator element 46 can be defaulted to the “off” position. A user actuating the accelerator element 46, such as by pushing on the accelerator element 46, can move the accelerator element 46 from the “off” position to the “on” position, thereby causing the cursor's speed to increase. The cursor's speed can continue increasing until the accelerator element 46 is again actuated, e.g., the user again presses on the accelerator element 46, so as to move the switch to the “off” position. The speed can gradually increase at a consistent rate when the switch is in the “on” position, or the speed can gradually increase at an inconsistent rate, e.g., exponentially, when the switch is in the “on” position such that the speed increases at a faster rate the longer the switch is in the “on” position. The cursor's speed can remain at the speed it was at when the switch was moved to the “off” position until the accelerator element 46 is again actuated or the decelerator element 48 is actuated.

The input to the accelerator element 46 can trigger the processor 16 to increase the cursor's speed. The accelerator element 46 can be configured to receive the input when the cursor 14 is stationary on the screen 12, e.g., is not moving on the screen 12, and when the cursor 14 is moving on the screen 12. A user can thus preemptively adjust the cursor's speed by actuating the accelerator element 46 prior to moving the cursor 14 via the stick 36 and/or the touchpad 38. Preemptively adjusting the cursor's speed can be desirable when, e.g., the user expects that the cursor will likely soon be moved a relatively large distance on the screen 12. A user can also adjust the cursor's speed in real time with the cursor's movement by actuating the accelerator element 46 while the cursor 14 is moving on the screen 12. The cursor's speed can thus be dynamically adjusted in real time with the cursor's movement in accordance with the user's preference based on any one or more factors, e.g., the user's visual perception of the cursor 14 on the screen 12, the user's agility in using the stick 36 and/or the touchpad 38, and/or a distance the cursor 14 is traversing across the screen 12.

The input to the accelerator element 46 can be non-directional, so as to not indicate an intended direction of the cursor's movement on the screen 12, and can lack distance information, so as to not indicate a distance the cursor 14 should be moved on the screen. The input to the pointing device, e.g., to the stick 36 and/or to the touchpad 38, requesting movement of the cursor 14 on the screen 14 can indicate a desired direction of the cursor's movement and a desired distance to move in the desired direction. The cursor's distance and directional movement can thus be independently controlled from the cursor's speed of movement, which can give a user more control in manipulating the cursor 14. For example, the input to the accelerator element 46 can be directed vertically, e.g., a downwardly directed force away from the inner surface 40 and toward a support surface (not shown) on which the base 34 rests, such as a tabletop. The input to the pointing device, on the other hand, can be directed horizontally, e.g., laterally, so as to indicate up-down-left-right directional movement of the cursor 14 on the screen 12. The input to the accelerator element 46 can thus be directed perpendicular to the input to the pointing device(s).

When operating a pointing device, a user usually actuates the pointing device using a finger, and a user generally applies more force to the pointing device when a higher velocity of cursor movement is desired. In other words, a user will generally push harder to make the cursor move faster. Due to the compliant nature of human fingers, the contact area between a finger and a surface against which it is pressed increases in proportion to the amount of force applied. This effect is increased when the surface is dome-shaped, as in the case with some conventional pointing sticks and with a contact surface of the stick 36 of FIG. 1. Pushing harder on the pointing device can cause user discomfort and injury. Similarly, repeated operation of a pointing device during a single session of using the device 10 and/or over the course of different use sessions over hours and/or days can cause user discomfort and injury, particularly if the display screen 12 is relatively large, has a relatively high resolution, and/or is spread over multiple screens and thereby requiring extended manipulation of the pointing device to move the cursor 14 therearound. The accelerator element 46 can help reduce, if not eliminate, user discomfort and injury caused by pointing device usage, by allowing the cursor 14 to selectively move at different speeds around the screen 12 and by separating cursor movement control (e.g., via a pointing device) from cursor speed control (e.g., via the accelerator and decelerator elements 46, 48). A user need not push harder on the pointing device with a finger to make the cursor move faster or slower since the user can control cursor speed independent of the cursor's distance and directional movement and can control cursor speed without using a finger, e.g., by using a palm of a hand.

The accelerator element 46 can be positioned a distance away from the electronic device's pointing device(s), which in the illustrated embodiment are the stick 36 and the touchpad 38. The distance between the accelerator element 46 and the pointing device(s) can be a horizontal or lateral distance, e.g., a distance along the inner surface, e.g., a first lateral distance d1 between the stick 36 and the accelerator element 46 and a second lateral distance d2 between the touchpad 38 and the accelerator element 46. The first lateral distance d1 is greater than the second lateral distance d2 in the illustrated embodiment, but the first and second lateral distances d1, d2 can be equal, or the second lateral distance d2 can be greater than the first lateral distance d1. By being spaced a lateral distance away from the pointing device(s), the accelerator element 46 can be less likely to be accidentally actuated when the pointing device(s) are actuated. In other words, the accelerator element 46 and the pointing device(s) can be better positioned for independent actuation as desired by a user, which can be simultaneous actuation or can be sequential actuation depending on a user's choice. Being spaced a lateral distance away from the pointing device(s) can allow the accelerator element 46 to be actuated with a different part of the same hand actuating the pointing device(s) or with a different hand than is actuating the pointing device(s). Stress can therefore be reduced on the part of the hand actuating the pointing device(s), typically a finger, thereby reducing chances of feeling pain or otherwise undesirably affecting the part of the hand actuating the pointing device(s).

In addition to the lateral distance between the accelerator element 46 and the pointing device(s), the distance between the accelerator element 46 and the pointing device(s) can be a non-zero vertical or depth distance. In the illustrated embodiment, a non-zero depth distance exists between the accelerator element 46, which is positioned below the base's inner surface 40, and the stick 36 and the touchpad 38, which are positioned on the base's surface inner 40. An accelerator element and the pointing device(s) can have a zero depth relative to one another, such as if the accelerator element and the pointing device(s) are all on a base's inner surface.

The decelerator element 48 can be configured and positioned similar to the accelerator element 46 except be configured to trigger a decrease, rather than an increase, in the cursor's speed on the screen 12. Reducing the cursor's speed can be desirable to, e.g., more accurately position the cursor 14 on a crowded display, more accurately position the cursor 14 over a small target area, more carefully draw a line using the cursor 14 as a painting stylus in a drawing program, reduce cursor speed after quickly moving the cursor 14 between large display screens, etc.

The accelerator and decelerator elements 46, 48 are each disposed within a housing of the electronic device, e.g., within the housing of the base 34, in the illustrated embodiment. The accelerator and decelerator elements 46, 48 can thus be invisible to a user during ordinary use of the electronic device 10. The base 34 can therefore visually appear like a base that the user may already be familiar with, namely a base that does not include accelerator or decelerator elements. The device 10 can thus be an attractive device to the user visually and/or in comfort-of-use. In another embodiment, one or both of the accelerator and decelerator elements 46, 48 can be on the inner surface 40 so as to be visible to a user similar to the stick 36, the touchpad 38, and the selection button 42. The accelerator and decelerator elements 46, 48 being visible can facilitate actuation thereof by allowing the user to visually confirm that the accelerator and decelerator elements 46, 48 are being actuated as desired and/or by facilitating the user's positioning of one or both of their hands relative to the device 10 to ensure that at least one of their hands is positioned adjacent the accelerator and decelerator elements 46, 48.

The accelerator and decelerator elements 46, 48 can be configured to be tactilely perceptible by a user whether the accelerator and decelerator elements 46, 48 are disposed within the electronic device's housing or are on the base's inner surface 40. The accelerator and decelerator elements 46, 48 can be tactilely perceptible in a variety of ways, e.g., by a switch or a sensor being palpable through the base's inner surface 40 or by the inner surface 40 having a palpable textured pattern thereon above locations of the accelerator and decelerator elements 46, 48. Being tactilely perceptible can help the user confirm that the accelerator and decelerator elements 46, 48 are being actuated as desired and/or can facilitate the user's positioning of one or both of their hands relative to the device 10 to ensure that at least one of their hands is positioned adjacent the accelerator and decelerator elements 46, 48.

In addition to or instead of being tactilely perceptible, the accelerator and decelerator elements 46, 48 can be configured to trigger an audible sound when actuated. The decelerator elements 46, 48 can be audibly perceptible upon actuation in a variety of ways, such as by being a switch that clicks or otherwise makes a sound when actuated or by triggering the processor 14 to sound a noise, e.g., a beep, a click, etc., upon actuation. Being audibly perceptible can help the user confirm that the accelerator and decelerator elements 46, 48 are being actuated as desired.

When the accelerator and decelerator elements 46, 48 are positioned below the base's inner surface 40, as in the illustrated embodiment, the inner surface 40 of the base 34 can be configured to allow flexing or bending of the inner surface 40 at least in a region adjacent the accelerator and decelerator elements 46, 48 so as to facilitate actuation of the accelerator and decelerator elements 46, 48. The amount of flexing or bending can be slight, e.g., 0.1 mm of bend. The inner surface 40 can be formed of a hard material, as is common in traditional electronic device base surfaces, yet can still be configured to slightly flex or bend, such as by being formed from a relatively thin material with empty space between its underside surface and the accelerator and decelerator elements 46, 48. Alternatively, the inner surface 40 can be formed from a pliant or elastomeric material having a small amount of flexibility or bendability at least in a region adjacent the accelerator and decelerator elements 46, 48. As will be appreciated by a person skilled in the art, the pliant or elastomeric material can include any one or more materials.

The accelerator and decelerator elements 46, 48 can be positioned relative to the keyboard 15 such that when a user's hands are in a typical position for typing on the keyboard 15, at least one of the user's hands is positioned to actuate the accelerator element 46 and one of the user's hands, same or different from the hand positioned to actuate the accelerator element 46, is positioned to actuate the decelerator element 48. The stick 36, the touchpad 38, and the selection button 42 are also in positions relative to the keyboard 15 such that when a user's hands are in a typical position for typing on the keyboard 15, at least one of the user's hands is positioned to actuate each of the 36, the touchpad 38, and the selection button 42. In the illustrated embodiment, the accelerator and decelerator elements 46, 48 are both positioned to be actuated by a same hand of the user (the user's left hand) when the user's hands are in a typical position for typing on the keyboard 15.

The accelerator and decelerator elements 46, 48 can be configured to be actuated by a user's hand, and in particular by a palm of a user's hand. In this way, the electronic device's pointing device(s), e.g., the stick 36 and the touchpad 38, can be configured to be actuated by a finger of the user's hand, while the accelerator and decelerator elements 46, 48 can be configured to be actuated by the palm of the same hand or by the palm of the user's other hand. The accelerator element 46 and the decelerator element 48 can thus be actuated simultaneously with the pointing device(s) so as to speed up or slow down the cursor's movement while the cursor 14 is being moved via the pointing device(s). In other words, the cursor's speed can be adjusted in real time with the cursor's movement on the screen 12. A person's palm is generally stronger than a person's finger, so repeated cursor acceleration by actuating the accelerator element 46 with a palm and/or repeated deceleration by actuating the decelerator element 48 with a palm can be less likely to cause the user discomfort and/or injury associated with repeated use of a pointing device use. Additionally, a surface area of a person's palm that can rest on and/or near the inner surface 40 so as to be adjacent to the accelerator element 46 and the decelerator element 49 is larger than a surface area of a fingertip generally used to actuate a pointing device, so the accelerator and decelerator elements 46, 48 can be less stressful to actuate by allowing for more surface area of the user's hand to actuate the accelerator and decelerator elements 46, 48.

The accelerator and decelerator elements 46, 48 are both disposed on a left side of the base's inner surface 40 to the left of the stick 36 and to the left of the touchpad 38 in the illustrated embodiment, but accelerator and decelerator elements can instead both be on a right side of the base's inner surface 40 to the right of the stick 36 and to the right of the touchpad 38. Alternatively, accelerator and decelerator elements can be disposed on both left and right sides of the inner surface 40 such that the electronic device 10 includes two accelerator elements and two decelerator elements. Being positioned on both left and right sides of the base's inner surface 40 can better accommodate left and right handedness. In some embodiments, an electronic device can include accelerator and decelerator elements below a pointing device, e.g., below a touchpad, such that one or more of a user's fingers on one hand can actuate the touchpad and a palm of that same hand can actuate the accelerator and decelerator elements. In some embodiments, an electronic device can include accelerator and decelerator elements within an area of a pointing device, such as within an area of a touchpad or within an area of a mouse. If a touchpad is a pressure sensitive touchpad configured to allow pressure applied thereto to be sensed by one or more pressure sensors positioned below the touchpad, such as with the ForcePad, accelerator and decelerator elements in the form of pressure sensors can be positioned within the area of the touchpad in a lower region thereof so as to facilitate actuation thereof by a user's palm without the user having to reposition their hand to traditionally actuate the touchpad with their finger(s). If a mouse includes accelerator and decelerator elements therein, at least an area adjacent to the accelerator and decelerator elements can be configured to flex or bend to facilitate actuation of the accelerator and decelerator elements, similar to that discussed above regarding the inner surface 40.

The accelerator element 46 is positioned to the right of the decelerator element 48 in the illustrated embodiment, as “right” tends to indicate “up” and “left” tends to indicate “down,” such as with accelerator and brake pedals of a car. However, the accelerator element 46 can be positioned above the decelerator element 48 so as to intuitively position the speed increase element, the accelerator element 46, in an upper position and the speed decrease element, the decelerator element 48, in a lower position. The accelerator element 46 and the decelerator element 48 can be positioned in other positions relative to one another, such as one of the accelerator and decelerator elements 46, 48 being positioned on a right side of the inner surface 40 and the other of the of the accelerator and decelerator elements 46, 48 being positioned on a left side of the inner surface 40.

The electronic device 10 can be configured to store a last user-selected speed of the cursor 14 as the default speed. In other words, after a user actuates the accelerator element 46 and/or the decelerator element 48 so as to change the cursor's speed from the initial current speed to a new current speed, the electronic device 10 can be configured to store the new current speeds as the default speed. In this way, the next time the user provides an input to the stick 36 or the touchpad 38, the cursor 14 can be moved at the last user-selected speed, thereby reflecting a most recent preference of the user and thus most likely reflecting the currently desired cursor speed. The default speed can be saved in non-volatile memory such that the electronic device 10 retains the default speed even in the event of power shutdown. The cursor's speed can be changed again any number of times using the accelerator element 46 and/or the decelerator element 48 and can be similarly saved as the default speed any number of times.

FIGS. 3-6 illustrate various embodiments of the screen 12 and movement of the cursor 14 thereon. For clarity of illustration, FIGS. 3-6 do not show the cursor 14. A person skilled in the art will appreciate that the images and text shown on the screen 12 in the embodiments of FIGS. 3-6 are illustrative examples and that any number of these and/or different images and text can be shown on the display screen 12. The cursor 14 can be moved on the screen 12 in response to one or more inputs to the stick 36 and/or to the touchpad 38.

FIG. 3 illustrates an embodiment of the screen 12 in which an input to the stick 36 or the touchpad 38 causes the cursor 14 to be moved from a first position 50 to a second position 52 adjacent a target area 54. Because the first and second positions 50, 52 are relatively far apart from one another as nearly spanning an entire width of the screen 12, a user may choose to actuate the accelerator element 46 to increase the cursor's current speed so as to speed movement of the cursor 14 from the first position 50 to the second position 52 and therefore more quickly move to the target area 54.

FIG. 4 illustrates an embodiment of the screen 12 in which a first input to the stick 36 or the touchpad 38 causes the cursor 14 to be moved from a first position 56 to a second position 58 a first distance away from the first position 56, a second input to the stick 36 or the touchpad 38 causes the cursor 14 to move from the second position 58 to a third position 60 a second distance away from the second position 58 that is less than the first distance, and a third input to the stick 36 or the touchpad 38 causes the cursor 14 to move from the third position 60 to a fourth position 62 a third distance away from the third position 60 that is less than the second distance. Because the first and second positions 56, 58 are relatively far apart from one another as nearly spanning an entire width of the screen 12, a user may choose to actuate the accelerator element 46 to increase the cursor's current speed during at least a portion of the cursor's movement from the first position 56 to the second position 58. The user may then choose to actuate the decelerator element 48 to decrease the cursor's current speed so as to more finely move the cursor 14 the second and third distances. The user may choose to actuate the decelerator element 48 throughout movement from the second position 58 to the fourth position 62 or for only a portion thereof. The user may also choose to accelerate the cursor 14 via the accelerator element 46 after decelerating the cursor 14 via the decelerator element 48 if the cursor 14 is slowed down too much for the user's personal preference.

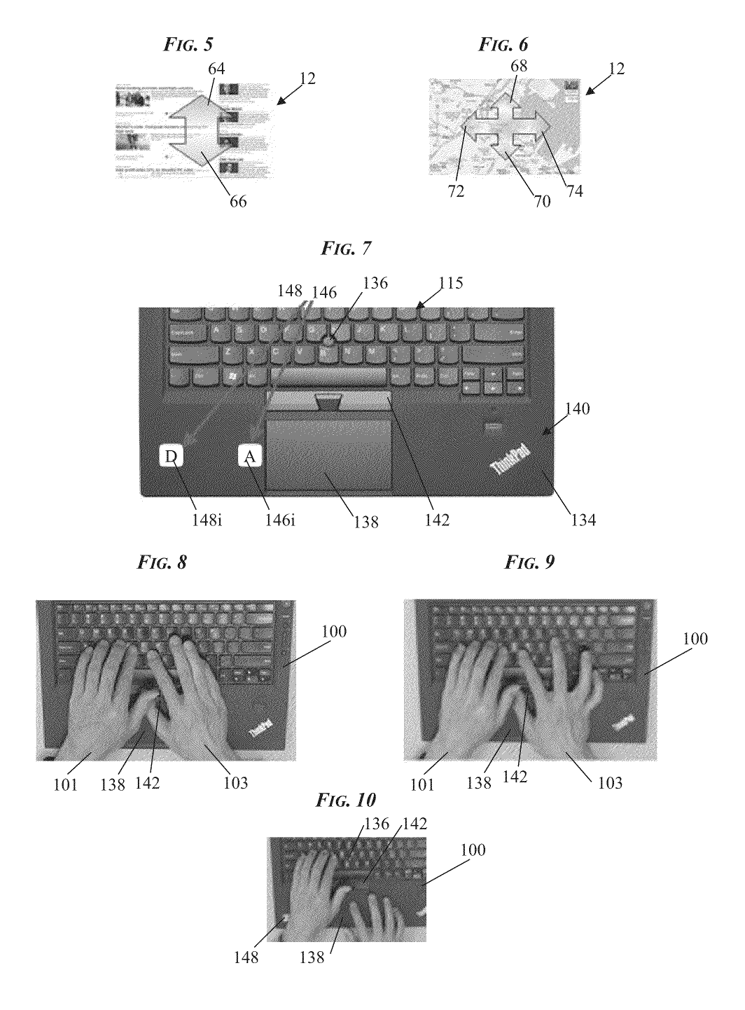

FIG. 5 illustrates an embodiment of the screen 12 in which an input to the stick 36 or the touchpad 38 causes the cursor 14 to be moved up from a first position to a second position or down from the first position to a third position so as to respectively scroll the screen 12 up in a direction shown by an up arrow 64 or down in a direction shown by a down arrow 66. If the user is scrolling up or down by a relatively large amount, the user may choose to actuate the accelerator element 46 to increase the cursor's current speed so as to move the cursor 14 up or down the screen 12 more quickly, e.g., to more quickly scroll up or down. When the cursor 14 approaches or reaches a target area (not shown) on the screen 12, the user may choose to actuate the decelerator element 48 so as to decrease the cursor's current speed and more finely guide the cursor 14.

FIG. 6 illustrates an embodiment of the screen 12 in which an input to the stick 36 or the touchpad 38 causes the cursor 14 to be moved up from a first position to a second position, down from the first position to a third position, left from the first position to a fourth position, or right from the first position to a fifth position so as to respectively scroll the screen 12 up in a direction shown by an up arrow 68, down in a direction shown by a down arrow 70, left in a direction shown by a left arrow 72, or right in a direction shown by a right arrow 74. If the user is scrolling up, down, left, right, or any combination thereof by a relatively large amount, the user may choose to actuate the accelerator element 46 to increase the cursor's current speed and move the cursor 14 up, down, left, and/or right the screen 12 more quickly, e.g., to more quickly scroll around. When the cursor 14 approaches or reaches a target area (not shown) on the screen 12, the user may choose to actuate the decelerator element 48 so as to reduce the cursor's current speed and more finely guide the cursor 14.

Features discussed herein with reference to any electronic device can generally be configured similar to like-named features discussed herein.

FIG. 7 illustrates another embodiment of an electronic device 100 (partially shown) configured to allow selective acceleration of a cursor (not shown) on a display screen (not shown) using an accelerator element 146 and a decelerator element 148. The accelerator and decelerator elements 146, 148 in this illustrated embodiment are visible on an inner surface 140 of the electronic device's base 134, which can help a user determine whether his/her hand is positioned so as to actuate the accelerator and decelerator elements 146, 148. The electronic device 100 in this illustrated embodiment includes a first pointing device in the form of a stick 136 on the inner surface 140 of the base 134, a second pointing device in the form of a touchpad 136 on the inner surface 140 of the base 134, a selection button 142 on the inner surface 140 of the base 134, and a keyboard 115 on the inner surface 140 of the base 134.

As in this illustrated embodiment, the accelerator and decelerator elements 146, 148 can each include an identifier configured to uniquely identify the accelerator element 146 as an accelerator and the decelerator element 148 as a decelerator. The identifiers can have a variety of configurations, such as any one or more of a differently colored light (e.g., backlight) for each of the accelerator and decelerator elements 146, 148, a differently colored button for each of the accelerator and decelerator elements 146, 148, an alphabetical and/or numeric marker on at least one of the accelerator and decelerator elements 146, 148, and a symbol marker on at least one of the accelerator and decelerator elements 146, 148. In the illustrated embodiment, the accelerator and decelerator elements 146, 148 each include an identifier 146i, 148i in the form of a different alphabetical marker, “A” for the acceleration element 146 and “D” for the deceleration element 148.

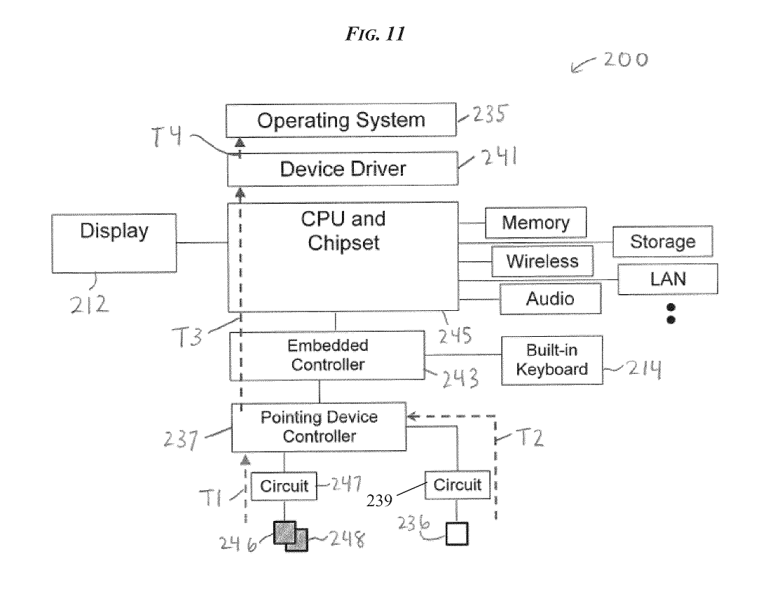

FIGS. 8-10 illustrate various embodiments of the electronic device 100 with left and right hands 101, 103 of a user positioned typical typing positions. FIG. 8 illustrates the right hand 103 in position to actuate the stick 136 (obscured in FIG. 8) with a forefinger thereof and in position to actuate the selection button 142 with a thumb thereof. FIG. 8 also shows the left hand 101 in position to actuate the accelerator and decelerator elements 146, 148 (both obscured in FIG. 8) with a palm thereof. The user can thus move the cursor by selectively using the stick 136 with the right hand 101, and the user can speed up and/or slow down the cursor's current speed with the left hand 103. FIG. 9 illustrates the left and right hands 101, 103 in different positions than in FIG. 8 but also with the right hand 103 in position to actuate the stick 136 (obscured in FIG. 9), with the forefinger of the right hand 103 in position to actuate the selection button 142 with the thumb thereof, and with the left hand 101 in position to actuate the accelerator and decelerator elements 146, 148 (both obscured in FIG. 9) with the palm thereof. FIG. 10 illustrates the left and right hands 101, 103 in different positions than in FIGS. 8 and 9. In FIG. 10, the right hand 103 is in position to actuate the touchpad 138 with the forefinger thereof, and the left hand 101 is in position to actuate the selection button 142 with a thumb thereof and the accelerator and decelerator elements 146, 148 (the accelerator element 148 is obscured in FIG. 10) with the palm thereof.

FIG. 11 illustrates another embodiment of an electronic device 200 configured to allow selective acceleration of a cursor (not shown) on a display screen 212 using an accelerator element 246 and a decelerator element 248. The accelerator and decelerator elements 246, 248 are overlapping in FIG. 11 for schematic illustrative purposes and would not be physically overlapping so as to help facilitate clear user selection of cursor acceleration or deceleration. The electronic device's keyboard 214 is shown as being a built-in keyboard, but the keyboard can be a removable and replaceable I/O device.

FIG. 11 illustrates an embodiment of how a user's input to the accelerator and decelerator elements 246, 248 can be transmitted so as to adjust a current speed of the cursor. FIG. 11 also illustrates an embodiment of how a user's input to a pointing device can be transmitted so as to cause movement of the cursor on the screen 212. The data transmission discussed below is with reference to input to the accelerator element 246. Data can be similarly transmitted for the decelerator element 248.

When a user provides an input to the accelerator element 246, e.g., by pushing down thereof so as to activate a pressure sensor, cursor speed data can be transmitted T1 from the accelerator element 246 to a pointing device controller 237 via a control circuit 247 configured to provide control for the accelerator and decelerator elements 246, 248, such as to provide amplification of a pressure sensor signal. Although one control circuit 247 is shown in the illustrated embodiment for both the accelerator and decelerator elements 246, 248, each of the accelerator and decelerator elements 246, 248 can have a dedicated control circuit.

When a user provides an input to a pointing device, which in the illustrated embodiment includes a stick 236, cursor directional and distance data can be transmitted T2 from the stick 236 to the pointing device controller 237 via a control circuit 239 configured to provide control for the stick 236. Although dedicated control circuits 247, 239 are shown in the illustrated embodiment for the accelerator and decelerator elements 246, 248 and the pointing device, one control circuit can provide control for all of the stick 236 and the accelerator and decelerator elements 246, 248.

The pointing device controller 237 can be configured to transmit T3 the cursor directional and distance data and the cursor speed data to a device driver 241 via an embedded controller 243 and a processor 245, e.g., a CPU and chipset. The data transmitted T3 by the pointing device controller 237 can be altered from the cursor directional and distance data and the cursor speed data received from the stick 236 and the accelerator device 246, such as by being combined into one data set, by including current speed data adjusted to account for the acceleration indicated by the cursor speed data, etc. The device driver 241 can be configured to transmit T4 its received data to an operating system 235 configured to trigger the processor 245 to cause the cursor to move a distance on the display 212 in a direction and with a speed indicated by the user's inputs. The data transmitted T4 by the device driver 241 can be altered from the data received from the pointing device controller 237, such as by combining the cursor directional and distance data and the cursor speed data into one data set, by including current speed data adjusted to account for the acceleration indicated by the cursor speed data, etc.

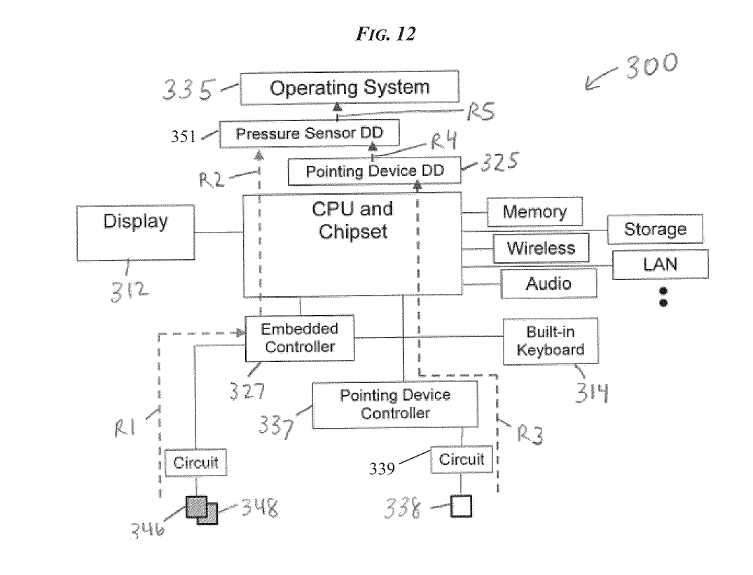

FIG. 12 illustrates another embodiment of an electronic device 300 configured to allow selective acceleration of a cursor (not shown) on a display screen 312 using an accelerator element 346 and a decelerator element 348. The accelerator and decelerator elements 346, 348 are overlapping in FIG. 12 for schematic illustrative purposes and would not be physically overlapping so as to help facilitate clear user selection of cursor acceleration or deceleration. The electronic device's keyboard 314 is shown as being a built-in keyboard, but the keyboard can be a removable and replaceable I/O device.

FIG. 12 illustrates another embodiment of how a user's input to the accelerator and decelerator elements 346, 348 can be transmitted so as to adjust a current speed of the cursor. FIG. 12 also illustrates an embodiment of how a user's input to a pointing device can be transmitted so as to cause movement of the cursor on the screen 312. The data transmission discussed below is with reference to input to the accelerator element 346. Data can be similarly transmitted for the decelerator element 348.

When a user provides an input to the accelerator element 346, e.g., by pushing down thereof so as to activate a pressure sensor, cursor speed data can be transmitted R1 from the accelerator element 346 to an embedded controller 327 via a control circuit 347 configured to provide control for the accelerator and decelerator elements 246, 248. The embedded controller 327 can be configured to transmit R2 the cursor speed data to an accelerator/decelerator device driver, which in the illustrated embodiment includes a pressure sensor device driver (DD) 351, via a processor 345.

When a user provides an input to a pointing device, which in the illustrated embodiment includes a non-stick pointing device such as a touchpad 338, cursor directional and distance data can be transmitted R2 from the touchpad 338 to a pointing device controller 337 via a control circuit 339 configured to provide control for the touchpad 338. The pointing device controller 337 can be configured to transmit R3 the cursor directional and distance data to a pointing device DD 325 via the processor 345. The pointing device DD 325 can be configured to transmit R4 its received data to the pressure sensor DD 351, which can be configured to transmit R5 the received cursor speed data and received cursor directional and distance data to an operating system 335. Similar to that discussed above regarding FIG. 11, the transmitted data can be altered from the data received.

Although the invention has been described by reference to specific embodiments, a person skilled in the art will understand that numerous changes may be made within the spirit and scope of the inventive concepts described. A person skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. An apparatus, comprising:
a pointing device configured to receive a first input from a first hand of a user, the first input indicating a request that a cursor move on a display screen from a first position on the screen to a second position on the screen; and
an accelerator element configured to receive a second input from a second hand of the user simultaneously with receipt of the first input, the second input indicating a request that the cursor to move on the screen as requested by the first input at a speed greater than a current speed of the cursor.

2. The apparatus of claim 1, wherein a time duration of the second input indicates how much to increase the speed over the current speed.

3. The apparatus of claim 1, wherein the first speed gradually increases until the accelerator element ceases to receive the second input.

4. The apparatus of claim 1, further comprising a decelerator element configured to receive a third input from the second hand of the user simultaneously with receipt of the first input, the third input requesting that the cursor to move on the screen as requested by the first input at a speed less than the current speed of the cursor.

5. The apparatus of claim 1, further comprising a housing of an electronic device, and a keyboard coupled to the housing; wherein
the pointing device is coupled to the housing at a first lateral location relative to the keyboard; and
the accelerator element is coupled to the housing at a second lateral location relative to the keyboard that is different than the first lateral location.

6. The apparatus of claim 5, wherein when the first and second hands of the user are in a typical position for typing on the keyboard, the pointing device is configured to receive the first input from a finger of the first hand of the user and the accelerator element is configured receive the second input from a palm of the second hand of the user.

7. The apparatus of claim 1, wherein the pointing device comprises at least one of a stick, a mouse, a touchpad, a jog ball, and an optical scanner.

8. The apparatus of claim 1, wherein the accelerator element comprises at least one of a pressure sensor and a switch.

9. An apparatus, comprising:
a pointing device configured to receive a first input from a user, the first input indicating a request for a cursor to move on a display screen;
an accelerator element separated at a distance from the pointing device, the accelerator element being configured to receive a second input from the user, the second input indicating a request for the cursor to move on the screen at a first speed greater than a current speed of the cursor; and
a processor configured to
prior to the accelerator element receiving the second input, cause the cursor to move on the screen at the current speed in response to the first input, and
after the accelerator element receives the second input, cause the cursor to move on the screen at the first speed in response to the first input.

10. The apparatus of claim 9, wherein a time duration of the second input indicates how much to increase the first speed over the current speed.

11. The apparatus of claim 9, wherein the processor is configured to gradually increase the first speed until the accelerator element ceases to receive the second input.

12. The apparatus of claim 9, further comprising a decelerator element separated at a second distance from the pointing device and separated at a third distance from the accelerator element, the decelerator element being configured to receive a third input from the user, the third input indicating a request for the cursor to move on the screen;
wherein the processor is configured to
prior to the accelerator element receiving the second input and prior to the decelerator element receiving the third input, cause the cursor to move on the screen at the current speed in response to the first input, and
prior to the accelerator element receiving the second input and after the decelerator element receives the third input, cause the cursor to move on the screen at a second speed in response to the first input, the second speed being less than the current speed.

13. The apparatus of claim 12, wherein the processor is configured to, after the accelerator element receives the second input and after the decelerator element receives the third input, cause the cursor to move on the screen at a third speed in response to the first input, the third speed being less than the first speed.

14. The apparatus of claim 9, further comprising a decelerator element separated at a second distance from the pointing device and separated at a third distance from the accelerator element, the decelerator element being configured to receive a third input from the user, the third input indicating a request for the cursor to move on the screen;
wherein the processor is configured to
after the accelerator element receives the second input and prior to the decelerator element receiving the third input, cause the cursor to move on the screen at the first speed in response to the first input, and
after the accelerator element receives the second input and after the decelerator element receives the third input, cause the cursor to move on the screen at a second speed in response to the first input, the second speed being less than the first speed.

15. The apparatus of claim 9, wherein the pointing device is configured to receive the first input from a first hand of the user and the accelerator element is configured receive the second input from a second hand of the user simultaneously with the pointing device receiving the first input.

16. The apparatus of claim 9, wherein the accelerator element includes a pressure sensor, and the processor is configured to increase the first speed according to a level of pressure detected by the pressure sensor as the second input.

17. The apparatus of claim 9, wherein the pointing device comprises at least one of a stick, a mouse, a touchpad, a jog ball, and an optical scanner.

18. The apparatus of claim 9, wherein the accelerator element comprises at least one of a pressure sensor and a switch.

19. A method, comprising:
receiving a first input from a first hand of a user, the first input being received at a pointing device of an electronic device, and the first input indicating a request that a cursor move on a display screen of the electronic device from a first position on the screen to a second position on the screen;
receiving a second input from a second hand of the user, the second input being received at an accelerator element of the electronic device, and the second input indicating a request that the cursor move on the screen at a speed faster than a current speed of the cursor; and
moving the cursor on the screen as requested by the first input at the speed faster than the current speed of the cursor.

20. The method of claim 19, wherein a time duration of the second input indicates how much to increase the speed over the current speed, the speed gradually increasing until the second input ceases to be received at the accelerator element.
